(19) United States
(12) Patent Application Publication
(10) Pub. No.: US 2015/0202788 A1
(43) Pub. Date: Jul. 23, 2015

(54) PELLETIZING DEVICE WITH A CUTTING ROTOR

(71) Applicant: Automatik Plastics Machinery GmbH, Großostheim (DE)

(72) Inventor: Tim Harmon, Charlotte, NC (US)

(73) Assignee: Automatik Plastics Machinery GmbH, Großostheim (DE)

(21) Appl. No.: 14/158,719

(22) Filed: Jan. 17, 2014

(51) Int. Cl. B26D 7/26; B02C 18/14; B02C 18/18; B29C 47/00

(52) U.S. Cl. CPC B26D 7/2614; B29C 47/0066; B02C 18/148; B02C 18/186; B29L 2031/772

(57) ABSTRACT

The invention refers to a pelletizing device for cutting plastic strands into pellets having a cutting rotor (20) which is rotated by a drive system (22), and cutting blades (24) distributed over a circumference (26) of the cutting rotor (20) having cutting edges (78), root areas (44) of which cutting blades (24) are arranged in grooves (34) in the rotor body (20), each cutting blade (24) having a recess (46) parallel to the cutting edge (78), which recesses (46) are covered by one of the grooves (34) to receive and interact with one clamping device (48) being held in an opposite recess (42) in the rotor body (20), wherein each clamping device (48) comprises a radially extendable clamping sleeve (50) and a spreading device (58, 64, 70) to widen the clamping sleeve (50) at least radially with respect to the clamping sleeve (50). The invention is characterized in that only one clamping sleeve (50) per each cutting blade (24) is provided in the groove (34),

said recess (46) of the cutting blade (24) extends from one flat end (80) of the cutting blade (24) at least close to the other flat end (81) of the cutting blade (24), said clamping sleeve (50) having an outer contour (52) which fits within the recess (46) in the cutting blade (24) and the opposite recess (42).

### BACKGROUND

1. Field

The invention refers to a pelletizing device with a cutting rotor.

2. Related Art

Pelletizing devices for cutting plastic fibre strands into pellets with a cutting rotor are widely used in combination with plastic extruding devices. Generally, a cylindrical cutting rotor equipped with cutting blades rotates at high speed and provides plastic pellets for further processing steps. The cutting blades are distributed over the entire circumference of the rotor and connected to the rotor in a way that guarantees safe operation and low wear.

As opposed to earlier solutions, in which the cutting blades were soldered into grooves on the surface of the rotor body, it has been suggested that the blades are clamped into the grooves in different ways, e.g. mechanically or hydro-mechanically, so that the blades can be exchanged with less effort.

The publication U.S. Pat. No. 6,386,469 B1 has disclosed a granulating device with a cutting rotor with blades which are clamped using slotted, unthreaded clamping elements. The absence of threads on the clamping sleeve has the advantage that the clamping elements can easily be inserted into the provided recesses, which are easier to manufacture than threaded holes, and that no notching effects will occur, as opposed to previous solutions using screws.

However, this disclosure has the drawback that two clamping elements have to be inserted from two sides in order to guarantee a constant distribution of the clamping force, sufficient clamping force and stability. This makes both the production of the rotor body and the assembly of the cutting blades on the rotor complicated and expensive.

### SUMMARY

The object of the invention is to provide a pelletizing device, which overcomes the drawbacks of the prior art and, in particular, results in a cutting rotor with cutting blades that is manufactured and assembled in a quick and cost-efficient manner.

To this end, a pelletizing device for cutting plastic strands into pellets is provided, having a cutting rotor, which is rotated by a drive system, and cutting blades which are distributed over a circumference of the cutting rotor and have cutting edges and root areas. The cutting blades are arranged in grooves in the rotor body. Each cutting blade has a recess parallel to the cutting edge. The recesses are covered by one of the grooves to receive and interact with one clamping device which is held in an opposite recess in the rotor body. Each clamping device comprises a radially extendable sleeve and a spreading device to widen the clamping sleeve at least radially with respect to the clamping sleeve. According to the invention, only one clamping sleeve is provided in the groove per each cutting blade, and the recess of the cutting blade extends from one flat end of the cutting blade at least close to the other flat end of the cutting blade. Further, the clamping sleeve has an outer contour which fits within the recess in the cutting blade and the opposite recess. The solution according to the invention has the advantage of allowing for a strong fit of the locking device at lower cost of materials and lower production cost. Besides, the assembly of the cutting rotor proves to be easier.

Preferably the clamping sleeve is slotted in order to enable a radial extension. The radial extension requires less energy, and an elastic deformation can be achieved more easily than it would be in case of an unslotted sleeve.

According to a further aspect of the invention, the clamping sleeve does not extend beyond the recess of the cutting blade in axial direction. This results in lower material cost for the production of the clamping sleeves. Besides the overall width is smaller, which reduces the risk of damaging clamping sleeves from outside and of blocking the pellets flow.

Particularly, the clamping sleeve has the same length as the recess of the cutting blade in axial direction. In this way, the clamping sleeve and the flat ends of cutting blade form a surface, thereby minimizing the risk of accumulation of matter between the two recesses and providing easier access when assembling and disassembling the cutting rotor.

In a preferred embodiment of the invention, the clamping sleeve has a constant cylindrical outer shape over its length, simplifying the production of clamping sleeve greatly.

According to a further embodiment of the invention, the clamping sleeve with at least two cylindrical outer contours that have the same radius and are arranged in distance to each other has a higher surface pressure and, thus, facilitates an even tighter lock between the clamping sleeve and the two recesses.

Especially, the spreading device transfers at least a linear movement into a radial movement initiated by a drive element, since the required linear movement is very easy to initiate and no rotational movement or strutting apart is necessary. Thus, a simple assembly and a tight fit are achieved.

However, if the spreading device transfers a rotational movement into a linear movement and a radial movement to widen the clamping sleeve, the assembly is even more precise, and an even tighter fit can be achieved due to more flexibility regarding the adjustment of the clamping sleeve's inner contour.

In a preferred embodiment, the spreading device comprises a threaded rod which projects through a first and a second conical bushing which are supported and guided by the threaded rod. At least the first conical bushing has an internal thread which engages into the thread of the threaded rod and thereby moves the conical bushings together widening the clamping sleeve. The inner contour of the clamping sleeve is adapted to the outer contour of the bushings. This solution provides a tighter fit and a more flexible and precise way of adjusting the inner diameter of the clamping sleeve. Furthermore, an additional clamping force is generated by moving conical bushings together.

If at least two conical inner contours are arranged on each half of the clamping sleeve where each one decreases in the direction of the center of the clamping sleeve and each fits with one outer contour of one conical bushing, a very tight fit can be achieved. Above that the flexibility regarding the adjustment of the inner diameter and the clamping force are improved since the conical bushings can be moved towards each other in a precise way.

Preferably, the threaded rod has a rod head and the second conical bushing has a block on which the head of the rod acts for the linear movement of the conical bushings towards each other and for holding the conical bushing in a predetermined position in which the clamping sleeve is widened. According to this solution, only one thread is necessary, which makes the clamping device easier to manufacture. Other positive effects are the exact determination of the position of the bushings, an improved clamping force of the clamping sleeve, and a tight fit.

The invention is further improved if the threaded rod has at least the same length as the clamping sleeve. Thereby, a constant clamping force is effective onto the blade, and the clamping device is more stable.

If the threaded rod is only threaded in an area where the first conical bushing interacts with the clamping sleeve the manufacturing of the rod is simplified, which reduces costs.

According to a further aspect of the invention, the threaded rod head has a connection element to which the drive element can be coupled, in order to induce a drive force to merge the first conical bushing into the first inner conical contour of the clamping sleeve and the second conical bushing into the second inner conical contour of the clamping sleeve. Thereby the second conical bushing moves with its block against the head of the rod and widens the clamping sleeve towards the recess in the cutting blade and the opposite recess in the rotor body so that the cutting blade is connected to the rotor body in a form-fitting and force-fitting manner by means of the clamping sleeve when the threaded rod has been screwed in. By inducing one single drive force in one direction parallel to the cutting edge, due to their conical contours the two bushings are moved towards each other while they are widened, which results in a strong clamping force symmetrically distributed along the longitudinal axis of the clamping device.

If the connection element is formed by a hexagon socket in the rod head, the drive force can be induced easily by readily available tools, which makes this solution simple and cost effective.

Preferably the first and second conical bushings have the same shape and dimensions, which results in easier manufacturing of the bushings and further cost saving.

According to another advantageous solution, the first and second conical bushings have a different shape and dimension. This makes the bushings easier to distinguish from each other for assembly. Further, a clamping force variable along the longitudinal axis of the blade is achieved, depending on the shape and dimensions of the bushings.

In a preferred embodiment the decline and the length of the outer conical contour of the first conical bushing over the second conical bushing is different. In this way, a clamping effect is achieved more quickly, and the clamping force along the longitudinal axis of the clamping device can be varied.

If the decline and the length of the outer conical contour of the first conical bushing over the second conical bushing is more sharply declined and shorter, the clamping effect is achieved particularly quickly.

Especially at least one conical bushing has an identification showing whether it is a first conical bushing or a second conical bushing. An identifiable conical bushing can be used in fully automated assembly, if suitable reading devices are provided.

In another advantageous embodiment of the invention, each opposite recess in the rotor body corresponds to the recess in the cutting blade, and the two recesses, in cross section, form segments of a circle which are offset with respect to one another. Production and assembly of the pelletizing device are significantly simplified since a cylindrical or cone-shaped clamping device can be used, which is easy to produce and to insert. Besides, the offset between the two circle segments improves the clamping force.

It is particularly expedient to the simplification of production and assembly if each recess has the same inner contour over its length, since the clamping devices are even easier to manufacture and to insert.

In a preferred embodiment of the invention, the recess of the cutting blade extends from one flat end of the cutting blade to the other flat end of the cutting blade. The clamping device has the same length as the blade, which facilitates ideal stabilization and clamping effect along the entire length of the clamping device.

If the circle-segment cross section of each recess in the cutting blade is offset radially outwards with respect to the circle-segment cross section of the opposite recess in the rotor body, by engaging the clamping device the clamping force that is effective on the cutting blade is pushing the cutting blade radially inwards. This results in a tighter, more secure fit.

Preferably the clamping sleeves are made from spring steel or spring bronze. By using these materials, clamping sleeves with high yield strength can be provided at low cost.

A further improvement of the cutting rotor is achieved when the cutting blades are arranged in the rotor body, with their respective root areas in the grooves, with a uniform distribution on the rotor circumference. Preferably, they are positioned at an acute angle of less than 10 degrees with respect to the rotor axis of the cutting rotor. In this way, imbalances in the rotor movement are avoided and the root areas in the grooves provide stability, while the positioning at an acute angle allows a larger number of cutting blades and clean cutting of the plastic fibre strand.

According to another advantageous solution, the recess in the cutting blade is formed on the cutting edge side. This embodiment provides more stability, since longer portions of the cutting blades can be sustained by the grooves.

### BRIEF DESCRIPTION OF THE DRAWINGS

Further advantages, features and potential applications of the present invention may be gathered from the description which follows, in conjunction with the embodiments illustrated in the drawings.

Throughout the description, the claims and the drawings, those terms and associated reference signs as will be used are notable from the enclosed list of reference signs. In the drawings is shown

FIG. 1 an embodiment of the pelletizing device;

FIG. 2 a perspective view of the rotor body showing the inner contour and the outer contour;

FIG. 3a, b side views of the two axial ends of the rotor body with inserted cutting blades;

FIG. 4 a perspective view of the cutting blade;

FIG. 5a a cross-sectional view of the clamping device;

FIG. 5b a lateral view of the clamping device; and

### DETAILED DESCRIPTION

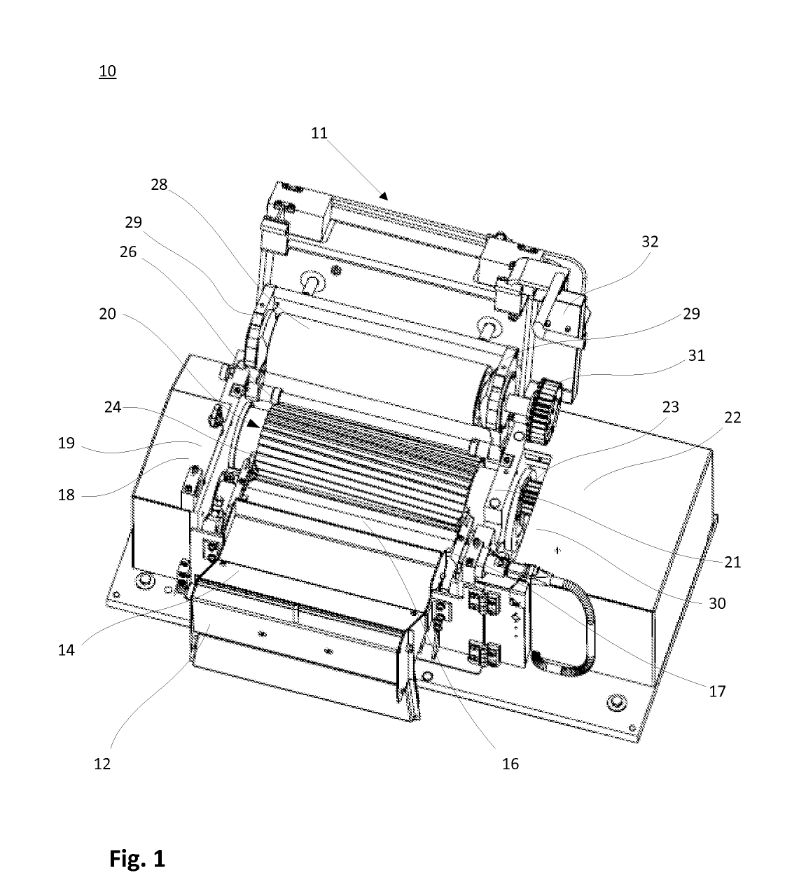

FIG. 1 shows an embodiment of the pelletizing device 10. For better illustration, the device is shown with an open top cover, henceforth called cutting chamber flap 11. At its front, the pelletizing device 10 has a housing flap 12 through which plastic fibre strands (not shown in this figure) are fed into an inlet chute 14. Subsequently, the plastic fibre strands are drawn further into the pelletizing device by two feed rolls 16, 28. The lower feed roll 16 is mounted on a bearing 17 and driven by a gear wheel 19 and a feed roll drive 18. The upper feed roll 28 is mounted on a bearing 29, which is attached to the cutting chamber flap 11, and driven by a gear wheel 31 and a feed roll drive 30. After passing the feed rolls 16, 28 the plastic fibre strands reach a cutting rotor 20, which is mounted on a bearing 21 and driven by a gear wheel 23 and a rotor drive 22. The cutting rotor 20 is equipped with cutting blades 24 on its circumferential surface 26 that cut the plastic fibre strands into plastic pellets. The pellets leave the pelletizing device 10 through an opening on the bottom side of the pelletizing device 10.

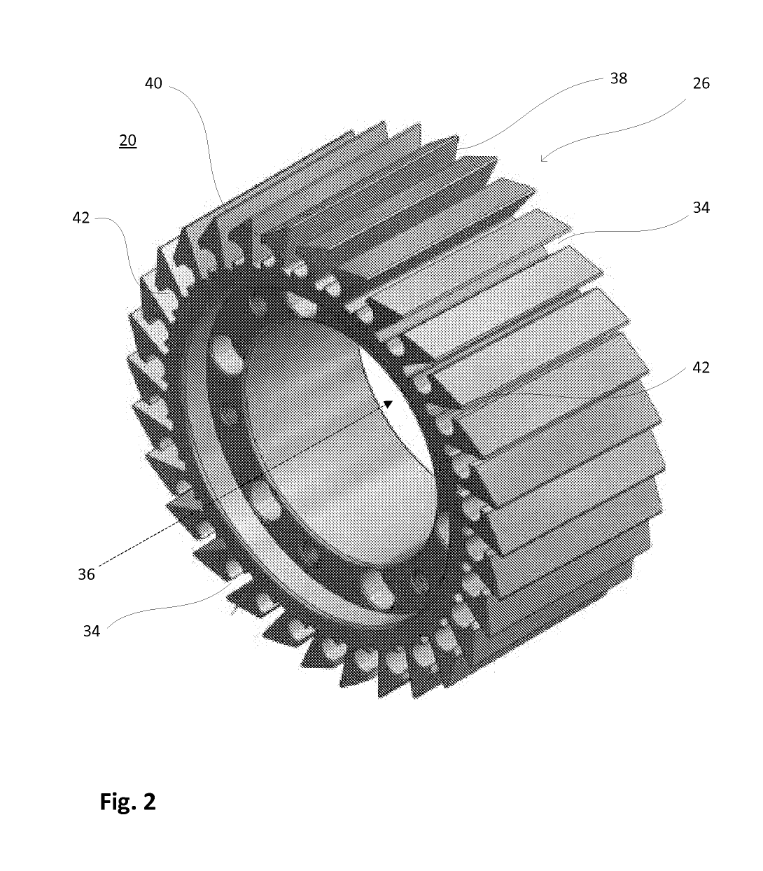

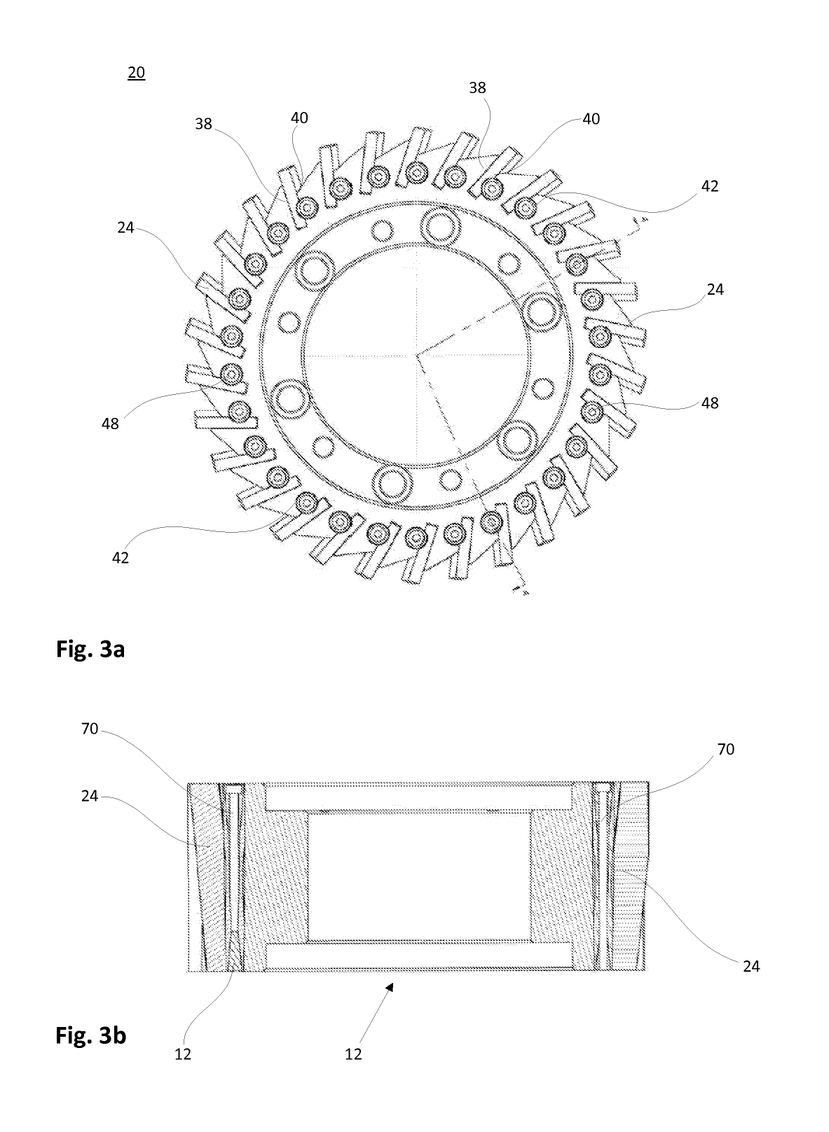

FIG. 2 shows a perspective view of the cutting rotor 20. The cutting rotor 20, on its outer circumferential surface 26, has grooves 34 that are formed parallel to the rotor axis 36. Each groove 34 has a long side 38 with an acute setting angle with respect to the radial direction of the cutting rotor 20 and a short side 40 with a recess 42 that extends parallel to the rotor axis 36. In an operational state, the groove 34 holds a cutting blade, see FIG. 3.

FIG. 3a shows a side view of one axial end of the cutting rotor 20 with inserted cutting blades 24. A cross-sectional view of an inserted cutting blade 24 according to the line A-A is shown in FIG. 3b. The cutting blades 24 are arranged in the body of the cutting rotor 20 with a uniform distribution on the circumferential surface 26, at an acute angle, in the axial direction, of less than 10 degrees with respect to the rotor axis of the cutting rotor 20. A root area 44 of each cutting blade 24 rests in a groove 34 and adopts a setting angle identical to the setting angle of the groove 34 when it is fixed in the groove 34. In vicinity to the root area 44, a recess 46 is provided in each cutting blade 24. Together, the recess 46 provided in the cutting blade 24 and the recess 42 provided in the short side 40 of the groove 34 form the shape of a circle, in which a clamping device 48 is inserted. Before engaging the clamping device, the recess 46 in the cutting blade 24 is offset radially outwards with respect to the circle-segment cross section of the opposite recess 42 in the cutting rotor 20 in cross section, so that by engaging the clamping device 50 the clamping force that is effective on the cutting blade 24 is pushing the cutting blade 24 radially inwards.

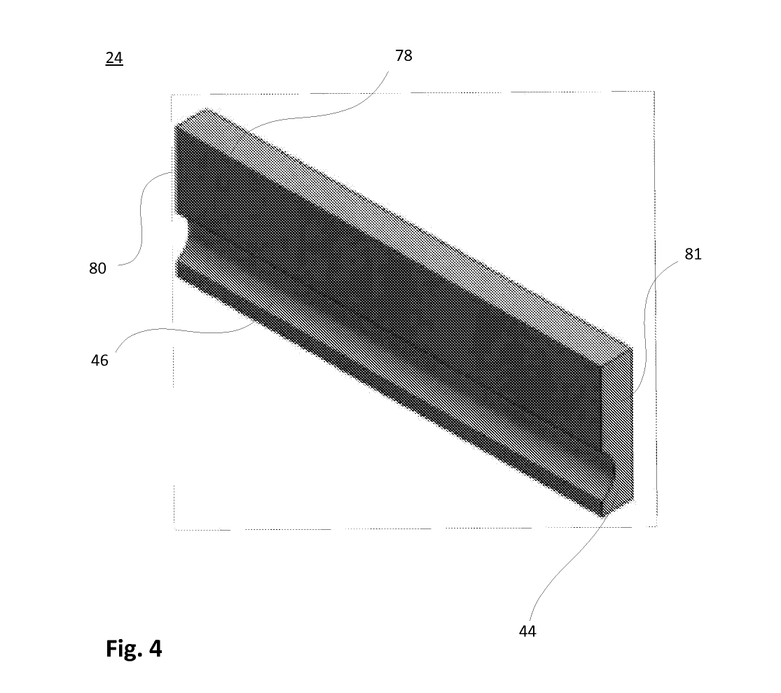

FIG. 4 shows a perspective view of the cutting blade 24. The cutting blade 24 has in cross-section a rectangular shape with a cutting edge 78, two flat ends 80, 81, a root area 44 and a recess 46. The root area 44 and the recess 46 are worked in the cutting blade 24.

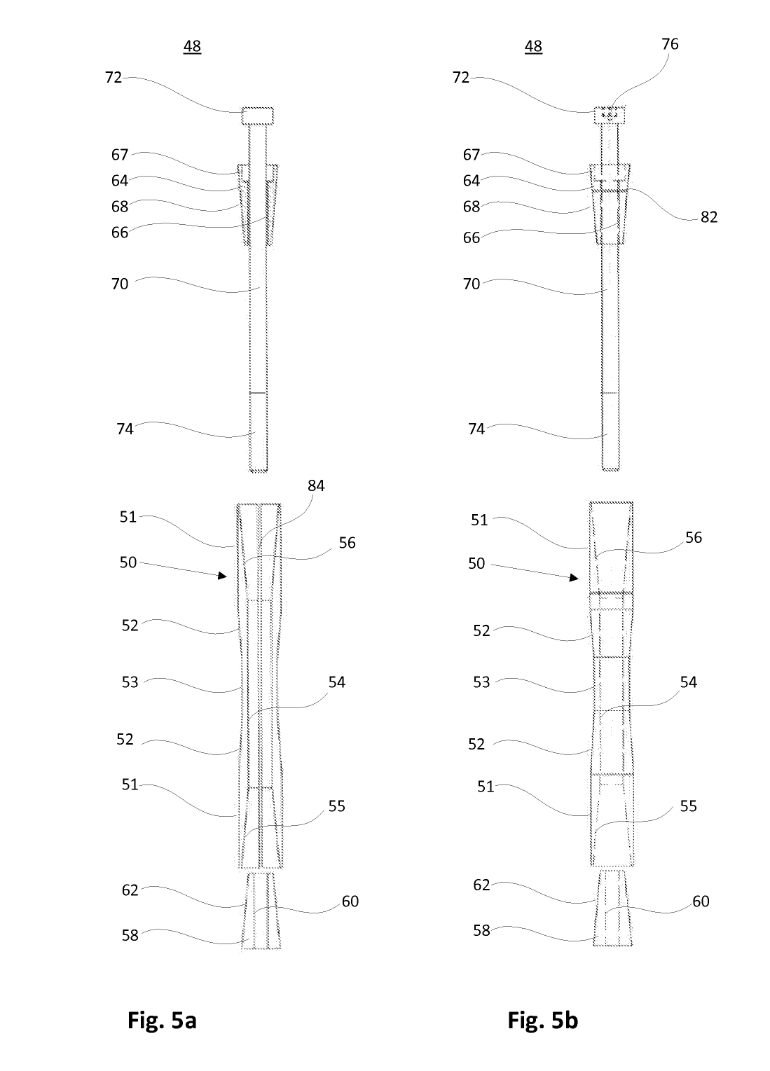

FIG. 5a shows a cross-sectional view of the clamping device 48, and FIG. 5b shows a lateral view of the clamping device 48 in analogy to FIG. 5a. The clamping device 48 has a clamping sleeve 50 with two cylindrical outer contours 51 at its ends, a cylindrical outer contour 53 with a smaller diameter in its central segment, and two outer contours 52 with increasing diameter between the outer contour 53 and the two outer contours 51. Further, the clamping device 48 has a cylindrical inner contour 54 in its central segment. The length of the clamping sleeve 50 corresponds to the axial length of the recess 46 of the cutting blade 24. From the central segment towards both ends of the clamping sleeve 50 the diameter of the inner contour increases gradually, thus forming a first inner contour 55 and a second inner contour 56. Both the outer contours 51, 53 and the inner contours 54, 55, 56 of the clamping sleeve 50 are unthreaded. One first conical bushing 58 with a threaded cylindrical inner contour 60 can be inserted into one end of the clamping sleeve 50. A first outer contour 62 of the first conical bushing 58 has the same gradient angle as the first inner contour 55 of the clamping sleeve 50, and its maximum outer diameter corresponds to the maximum inner diameter of the clamping sleeve 50, so that by inserting the first conical bushing 58 into the clamping sleeve 50 a form-fit between the first conical bushing 58 and the clamping sleeve 50 is achieved. At the other end of the clamping sleeve 50, a second conical bushing 64 with an identification 82 (only shown in FIG. 5b) and a second outer contour 68 is shown. The second conical bushing 64 has an unthreaded cylindrical inner contour 66, whose diameter is increased in the segment 67 adjacent to the end of the second conical bushing 64 with the maximum outer diameter.

A rod 70 with a length approximately identical to the length of the clamping sleeve 50 projects through the second conical bushing 64 and can be inserted into the clamping sleeve 50. At one end the rod 70 has a driving head 72 with a connection element 76 (only shown in FIG. 5b) to which a drive element can be coupled in order to induce a drive force onto the rod 70. The driving head 72 has approximately the same proportions as the segment 67 of the inner contour 66 of the second conical bushing 64 with an increased diameter, so that by inserting the rod 70 into the second conical bushing 64 a form-fit between the rod 70 and the second conical bushing 64 is achieved. At the other end, the rod 70 has a threaded segment 74. The threaded segment 74 of the rod 70 is formed in a manner that it engages with the threaded inner contour 60 of the first conical bushing 58 and has a length approximately identical to the length of the first conical bushing 58. By inserting the first conical bushing 58 and the second conical bushing 64 entirely into the clamping sleeve 50 and by additionally screwing the threaded segment 74 of the rod 70 into the first conical bushing 58, a tight force fit between the clamping sleeve 50, the first conical bushing 58, the second conical bushing 64, and the rod 70 is achieved. Since the first conical bushing 58 is shorter and its outer contour 62 has a higher gradient angle than the second conical bushing 64, the clamping effect is achieved particularly quickly. Due to a slot 84 along the entire length of the clamping sleeve 50 and the elasticity of the clamping sleeve 50, by applying an additional drive force onto the rod 70 and screwing the rod 70 further into the clamping sleeve 50 when inserted into the cylindrical clearance formed by the recess 42 and the recess 46, the diameter of the clamping sleeve 50 is increased, which results in a clamping effect that presses the cutting blade 24 firmly against the long side 38 of the groove 34.

### LIST OF REFERENCE SIGNS

10 pelletizing device
11 cutting chamber flap
12 housing flap
14 inlet chute
16 lower feed roll
17 bearing
18 lower feed roll drive
19 gear wheel
20 cutting rotor
21 bearing
22 rotor drive
23 gear wheel
24 cutting blade
26 circumferential surface
28 upper feed roll
29 bearing
30 upper feed roll drive
31 gear wheel
34 grooves
36 rotor axis
38 long side
40 short side
42 recess (rotor body)
44 root area
46 recess (blade)
48 clamping device
50 clamping sleeve
51 outer contour (edges)
52 outer contour (transition)
53 outer contour (central segment)
54 cylindrical inner contour
55 first inner contour
56 second inner contour
58 first conical bushing
60 threaded cylindrical inner contour
62 first outer contour
64 second conical bushing
66 inner contour
67 segment with increased diameter
68 second outer contour
70 rod
72 driving head
74 threaded segment
76 connection element
78 cutting edge
80 flat end
81 flat end
82 identification
84 slot

1. Pelletizing device for cutting plastic strands into pellets having
a cutting rotor which is rotated by a drive system, and
cutting blades distributed over a circumference of the cutting rotor having cutting edges, root areas of which cutting blades are arranged in grooves in the rotor body,
each cutting blade having a recess parallel to the cutting edge,
which recesses are covered by one of the grooves to receive and interact with one clamping device being held in an opposite recess in the rotor body,
wherein each clamping device comprises a radially extendable clamping sleeve and a spreading device to widen the clamping sleeve at least radially with respect to the clamping sleeve, wherein
only one clamping sleeve per each cutting blade is provided in the groove,
said recess of the cutting blade extends from one flat end (80) of the cutting blade at least close to the other flat end of the cutting blade, and wherein
said clamping sleeve having an outer contour which fits within the recess in the cutting blade and the opposite recess.

2. Pelletizing device according to claim 1, wherein the clamping sleeve is slotted to enable a radial extension.

3. Pelletizing device according to claim 1, wherein the clamping sleeve has the same length as the recess of the cutting blade in axial direction.

4. Pelletizing device according to claim 1, wherein the clamping sleeve has a constant cylindrical outer shape over its length.

5. Pelletizing device according to claim 1, wherein the clamping sleeve has at least two cylindrical outer contours having the same radius arranged in distance to each other.

6. Pelletizing device according to claim 1, wherein the spreading device transfers at least a linear movement into a radial movement initiated by a drive element.

7. Pelletizing device according to claim 6, wherein the spreading device transfers a rotational movement into a linear movement and a radial movement to widen the clamping sleeve.

8. Pelletizing device according to claim 1, wherein the spreading device comprises a threaded rod which projects through a first and a second conical bushing which are supported and guided by the threaded rod, wherein
at least the first conical bushing has an internal thread which engages into the thread of the threaded rod to move the conical bushings together to widen the clamping sleeve, and wherein
the inner contour of the clamping sleeve is adapted to the outer contour of the conical bushings.

9. Pelletizing device according to claim 6, wherein the clamping sleeve comprises at least two conical inner contours, arranged on each half of the clamping sleeve where each one decreases in the direction of a middle part of the clamping sleeve and each fits with one outer contour of one conical bushing.

10. Pelletizing device according to claim 6, wherein the threaded rod has a rod head and the second conical bushing has a block on which the head of the rod acts for the linear movement of the conical bushings towards each other and for holding the conical bushing in a predetermined position in which the clamping sleeve is widened.

11. Pelletizing device according to claim 6, wherein the threaded rod head has a connection element to which the drive element can be coupled to induce a drive force to merge the first conical bushing into the first inner conical contour of the clamping sleeve, the second conical bushing into the second inner conical contour of the clamping sleeve, wherein the second conical bushing moves with its block against the head of the rod, to widen the clamping sleeve towards the recess in the cutting blade and the opposite recess in the rotor body, so that the cutting blade is connected to the rotor body in a form-fitting and force-fitting manner by means of the clamping sleeve when the threaded rod has been screwed in.

12. Pelletizing device according to claim 11, wherein the connection element is formed by a hexagon socket in the rod head.

13. Pelletizing device according to claim 11, wherein the decline and the length of the outer conical contour of the first conical bushing over the second conical bushing is more sharply declined and shorter.

14. Pelletizing device according to claim 1, wherein at least one conical bushing has an identification showing whether it is a first conical bushing or a second conical bushing.

15. Pelletizing device according to claim 1, wherein each opposite recess in the rotor body corresponds to the recess in the cutting blade, and wherein both recesses, in cross section, form segments of a circle which are offset with respect to one another.

16. Pelletizing device according to claim 1, wherein each recess has the same inner contour over its length.

17. Pelletizing device according to claim 1, wherein the recess of the cutting blade extends from one flat end of the cutting blade to the other flat end of the cutting blade.

18. Pelletizing device according to claim 15, wherein the circle-segment cross section of the recess in the cutting blade is offset radially outwards with respect to the circle-segment cross section of the opposite recess in the rotor body.

19. Pelletizing device according to claim 1, wherein the cutting blades, with their root area in the grooves, are arranged in the rotor body with a uniform distribution on the rotor circumference, at an acute angle, in the axial direction, of less than 10 degrees with respect to the rotor axis of the cutting rotor.

20. Pelletizing device according to claim 1, wherein the recess in the cutting blade is formed on the cutting edge side.
